(19) United States
(12) Patent Application Publication
(10) Pub. No.: US 2004/0070901 A1
(43) Pub. Date: Apr. 15, 2004

(54) Electrostatic discharge protection circuit

(76) Inventor: Sadayoshi Umeda, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/643,082

(22) Filed: Aug. 19, 2003

(30) Foreign Application Priority Data
Aug. 27, 2002 (JP) 2002-246410

(51) Int. Cl. H02H 9/00

(52) U.S. Cl. 361/56

(57) ABSTRACT

There provided an electrostatic discharge protection circuit for preventing a damage to a transistor due to an ESD surge. In the protection circuit, a first and a second signal line serving as a source or a drain of a transistor Tr1 are connected to a first and a second power source terminal, respectively. A first diode has an anode connected to the first signal line and a cathode connected to a back gate of the transistor and a cathode of a second diode. The second diode has an anode connected to the second signal line 2. Thus, the source and drain of the transistor Tr1 are switched to each other in accordance with an ESD surge voltage generated in the first and the second signal line. Therefore, an ESD surge current runs through a source-drain path without producing a parasitic action in a well tap of the source and the drain, thereby preventing a damage to the transistor Tr1.

### CROSS-REFERENCE TO RELATED APPLICATIONS

This application is based upon and claims the benefits of priority from the prior Japanese Patent Application No. 2002-246410, filed on Aug. 27, 2002, the entire contents of which are incorporated herein by reference.

### BACKGROUND OF THE INVENTION

1. Field of the Invention

The present invention relates to an electrostatic discharge protection circuit, more specifically to an electrostatic discharge protection circuit for protecting an internal circuit of a semiconductor device against electrostatic discharge.

2. Description of the Related Art

An internal circuit of an LSI can be damaged by electrostatic discharge (ESD) that is generated by contact with a human being, the friction against a housing, or the like. In order to protect the internal circuit against the ESD, the LSI comprises an ESD protection circuit connected to power source terminals and an input/output terminal.

FIG. 3 illustrates a conventional ESD protection circuit. As shown in FIG. 3, the ESD protection circuit comprises an internal circuit 30, diodes D7 and D8, a transistor Tr2, a resistor R2 and a condenser C3.

The internal circuit 30 is a circuit formed in the LSI and connected with an input/output terminal V for inputting/outputting a signal and power source terminals VS and VD for inputting power sources. The power source terminal VS is supplied with the power source of a negative voltage, and the power source terminal VD that of a positive voltage. Specifically, the power source terminals VS and VD are connected to the ground of the power source and the positive voltage side of the power source, respectively.

The cathode of the diode D7 is connected to the power source terminal VD, while the anode thereof the input/output terminal V. The cathode of the diode D8 is connected to the input/output terminal V, and the anode thereof the power source terminal VS.

The transistor Tr2 is a P-channel MOS transistor. The transistor Tr2 has a source and a drain that are connected with the power source terminal VD and the power source terminal VS, respectively.

The resistor R2 has an end connected with the power source terminal VD and the other end connected with the gate of the transistor Tr2.

Moreover, the condenser C3 is connected with the gate of the transistor Tr2 at its end, and is also connected with the power source terminal VS at the other end.

The operation of the ESD protection circuit will be explained below.

Providing that the power source terminal VD is supplied with a positive direct current voltage, an electric current does not run through the resistor R2 due to high impedance of the gate of the transistor Tr2 and of the condenser C3. Therefore, the source-gate path of the transistor Tr2 has the equivalent potential and is in an OFF state. In other words, the internal circuit 30 is supplied with a power source voltage and performs the predetermined operation.

Given that a positive ESD surge based on the power source terminal VS occurs in the input/output terminal V, the potential of the input/output terminal V rises due to the ESD surge. In the power source terminal VD, the potential that is dropped by amount of a forward voltage with respect to the potential of the input/output terminal V is produced due to the diode D7.

Connected between the power source terminals VS and VD is a series circuit comprising the resistor R2 and the condenser C3. When the voltage rises due to the ESD surge, the current caused by the ESD surge (ESD surge current) runs through the series circuit having the resistor R2 and the condenser C3. The condenser C3 is charged in accordance with a CR time constant of the resistor R2 and that of the condenser C3.

During the CR time constant in which the condenser C3 is charged, there generates a potential difference in the source-gate path of the transistor Tr2, and the source-drain path is brought into an ON state (conducting state). Accordingly, the ESD surge current flows through the source-drain path of the transistor Tr2. In other words, the current caused by the positive ESD surge that occurs in the input/output terminal V on the basis of the power source terminal VS runs through the diode D7, the source-drain path of the transistor Tr2 and the power source terminal VS. Thus, the internal circuit 30 is protected.

If the positive ESD surge based on the power source terminal VS occurs in the power source terminal VD, the transistor Tr2 operates in the same manner as the above case, thereby protecting the internal circuit 30 against the ESD surge current. Likewise, in cases where a negative ESD surge based on the power source terminal VD occurs in the input/output terminal V, the transistor Tr2 operates similarly to the above case. Therefore, the ESD surge current runs through the source-drain path of the transistor Tr2, the diode D8 and the input/output terminal V, which protects the internal circuit 30.

Granting that the negative ESD surge based on the power source terminal VS occurs in the input/output terminal V, the ESD surge current flows in a forward direction following the power source terminal VS and the diode D8, and runs into the input/output terminal V. As a result, the internal circuit 30 is protected against the ESD surge current.

If the positive ESD surge based on the power source terminal VD occurs in the input/output terminal V, the ESD surge current flows in the forward direction following the input/output terminal V and the diode D7, and runs into the power source terminal VD. Thus, the internal circuit 30 is protected against the ESD surge current.

In case that the negative ESD surge based on the power source terminal VS occurs in the power source terminal VD, the ESD surge current runs through the power source terminal VS, a parasitic diode between the drain and the back gate of the transistor Tr2 (bipolar transistor), the diodes D8 and D7, and the power source terminal VD. Consequently, the internal circuit 30 is protected against the ESD surge current.

However, if the negative ESD surge based on the power source terminal VS occurs in the power source terminal VD, the negative voltage is applied to the source of the transistor Tr2, and the positive voltage is applied to the drain thereof. Thus, there occurs a parasitic action (diode action whose forward direction follows the power source terminal VS and the power source terminal VD) in a well tap of the drain and source of the transistor Tr2 to produce a current, thereby causing a damage.

### SUMMARY OF THE INVENTION

The present invention was created in view of the above circumstances, and an object thereof is to provide an electrostatic discharge protection circuit for preventing a damage to a transistor due to electrostatic discharge.

In order to achieve the above object, there provided an electrostatic discharge protection circuit for protecting an internal circuit of a semiconductor device against the electrostatic discharge. The electrostatic discharge protection circuit comprises an internal circuit connected with a first and a second power source terminal, a transistor switching a source and a drain which are connected to the first and the second power source terminal, respectively, by using voltage supplied to a back gate thereof, a first diode connected between the first power source terminal and the back gate, the first diode supplying a positive discharge voltage produced in the first power source terminal to the back gate, a second diode connected between the second power source terminal and the back gate, the second diode supplying a positive discharge voltage produced in the second power source terminal to the back gate, and a voltage-dividing circuit dividing and supplying the discharge voltage to the gate of the transistor and controlling ON/OFF operation of the source-drain path.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an ESD protection circuit according to a first embodiment of the present invention;

FIG. 2 shows an ESD protection circuit according to a second embodiment of the present invention; and

FIG. 3 shows a conventional ESD protection circuit.

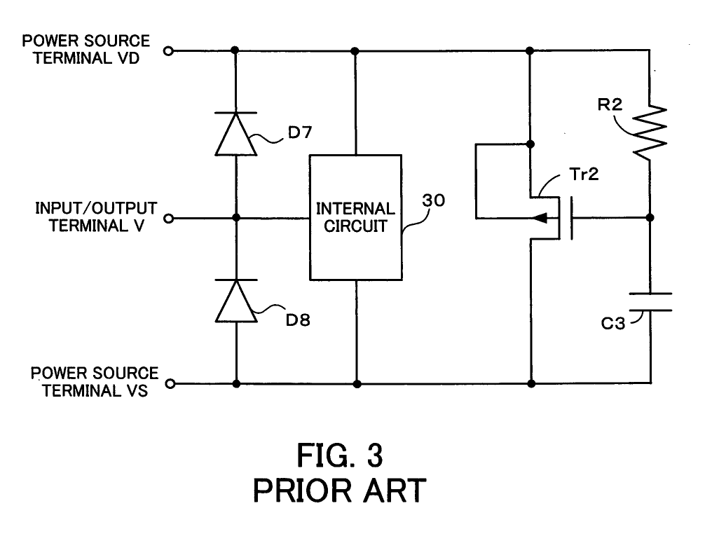

### DESCRIPTION OF THE PREFERRED EMBODIMENTS

A first embodiment of the present invention will be hereinafter described with reference to the drawings.

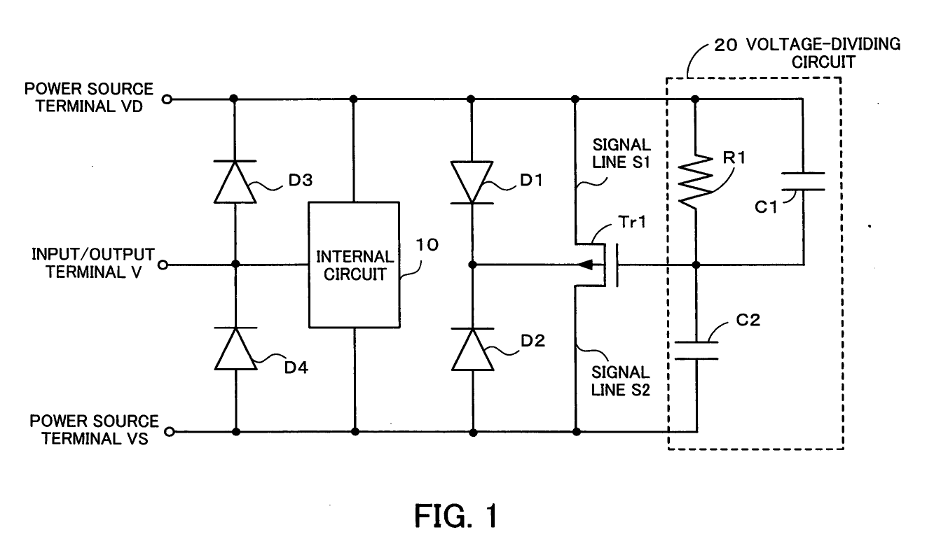

FIG. 1 illustrates an ESD protection circuit according to the first embodiment of the present invention. The ESD protection circuit is formed on a semiconductor chip of a semiconductor device for the purpose of protecting an internal circuit of the semiconductor device against an ESD surge which occurs in an input/output terminal and power source terminals of the semiconductor device.

As shown in FIG. 1, the ESD protection circuit comprises an internal circuit 10, a voltage-dividing circuit 20, diodes D1 to D4 and a transistor Tr1.

The internal circuit 10 is connected with an input/output terminal V and power source terminals VS and VD. The power source terminal VS is supplied with a power source of a negative voltage, while the power source terminal VD a power source of a positive voltage. More specifically, the power source terminal VS is connected to a ground of the power source, whereas the power source terminal VD is connected to a positive voltage side of the power source. The internal circuit 10 is supplied with power sources from the power source terminals VD and VS, inputs or outputs a signal with respect to the input/output terminal V, and performs a predetermined operation. In addition, the input/output terminal V may be replaced with a terminal only for inputting or the one only for outputting a signal.

The diode D1 has an anode connected with the power source terminal VD and a cathode connected with a back gate of the transistor Tr1. The diode D2 has a cathode connected with the back gate of the transistor Tr1 and an anode connected with the power source terminal VS.

The diode D3 has a cathode connected with the power source terminal VD and an anode connected with the input/output terminal V. The diode D4 has a cathode connected with the input/output terminal V and an anode connected with the power source terminal VS.

The transistor Tr1 is a P-channel MOS transistor having signal lines S1 and S2. The signal line S1 of the transistor Tr1 is connected with the anode of the diode D1 and the power source terminal VD, while the signal line S2 is connected with the anode of the diode D2 and the power source terminal VS. The back gate of the transistor Tr1 is connected with the cathode of the diode D1 and that of the diode D2.

The voltage-dividing circuit 20 divides voltages produced in the power source terminals VD and VS, and supplies the voltages to the gate of the transistor Tr1. The voltage-dividing circuit 20 comprises a resistor R1 and condensers C1 and C2. The resistor R1 has an end connected with the power source terminal VD and the other end connected with the gate of the transistor Tr1.

The condenser C1 has an end connected with the power source terminal VD and the other end connected with the gate of the transistor Tr1. The condenser C2 has an end connected with the power source terminal VS and the other end connected with the gate of the transistor Tr1. That is, the condenser C2 is series-connected with a parallel circuit comprising the resistor R1 and the condenser C1, and a junction of the condenser C2 and the parallel circuit is connected to the gate of the transistor Tr1.

Operation of the ESD protection circuit will be described below.

Supposing that a positive ESD surge based on the power source terminal VS occurs in the power source terminal VD, an ESD surge current is not produced since the diodes D3 and D4 are connected in a backward direction with respect to a polarity of an ESD surge voltage.

The power source terminal VD has higher potential than the power source terminal VS, and thus impedance of the diode D1 in light of a relation with the power source terminal VD is low (impedance of the diode D2 in light of a relation with the power source terminal VS is high). Therefore, the potential of the power source terminal VD is supplied to the back gate of the transistor Tr1 via the diode D1. As a result, the signal line S1 of the transistor Tr1 serves as a source, whereas the signal line S2 thereof functions as a drain.

Due to a voltage rise caused by the ESD surge, a series circuit comprising the condensers C1 and C2 is brought to be at a potential, which is produced by dividing a differential voltage between the power source terminal VD and the power source terminal VS, at a junction of the condensers C1 and C2 only at the moment of the ESD surge. The condensers C1 and C2 are charged in accordance with CR time constants of the resistor R1 and condensers C1 and C2.

At least during the CR time constant, the voltage of the gate of the transistor Tr1 is lower than that of the source (signal line S1) due to the voltage generated by dividing the differential voltage between the power source terminals VD and VS. Thus, the source-drain path of the transistor Tr1 is brought into an ON state. Therefore, the ESD surge current runs through the source-drain path of the transistor Tr1. That is, the current caused by the positive ESD surge that occurs in the power source terminal VD on the basis of the power source terminal VS runs through the source-drain path of the transistor Tr1 and the power source terminal VS, thus protecting the internal circuit 10.

In case that the positive ESD surge based on the power source terminal VS occurs in the input/output terminal V, the ESD surge current flows in a forward direction of the diode D3. The ESD surge current is not generated since the diode D4 is connected in a backward direction. The voltage of the power source terminal VD is lower by the forward voltage than that of the input/output terminal V.

Since the potential of the power source terminal VD is higher than that of the power source terminal VS, the impedance of the diode D1 in light of the relation with the power source terminal VD is low (the impedance of the diode D2 in light of the relation with the power source terminal VS is high). Therefore, the potential of the power source terminal VD is supplied to the back gate of the transistor Tr1 via the diode D1. Thus, the signal line S1 of the transistor Tr1 serves as a source, and the signal line S2 thereof a drain.

Due to the voltage rise caused by the ESD surge, the series circuit comprising the condensers C1 and C2 is brought to be at the potential, which is produced by dividing the differential voltage between the power source terminal VD and the power source terminal VS, at the junction of the condensers C1 and C2 at the moment of the ESD surge. The condensers C1 and C2 are charged in accordance with the CR time constants of the resistor RI and condensers C1 and C2.

At least during the CR time constant, the voltage of the gate of the transistor Tr1 is lower than that of the source (signal line S1) due to the voltage generated by dividing the differential voltage between the power source terminals VD and VS, which brings the source-drain path of the transistor Tr1 into the ON state. Therefore, the ESD surge current runs through the source-drain path of the transistor Tr1. In other words, the current caused by the positive ESD surge that occurs in the input/output terminal V on the basis of the power source terminal VS flows through the diode D3, the source-drain path of the transistor Tr1, and the power source terminal VS, and thus the internal circuit 10 is protected.

If a negative ESD surge based on the power source terminal VD occurs in the input/output terminal V, the current is not generated since the diode D3 is connected backward with respect to the polarity of the applied ESD surge voltage.

Since the potential of the power source terminal VD is higher than that of the power source terminal VS, the impedance of the diode D1 in light of the relation with the power source terminal VD is low (the impedance of the diode D2 in light of the relation with the power source terminal VS is high). Therefore, the potential of the power source terminal VD is supplied to the back gate of the transistor Tr1 via the diode D1. As a result, the signal line S1 of the transistor Tr1 functions as a source, and the signal line S2 thereof a drain.

Due to the voltage rise caused by the ESD surge, the series circuit comprising the condensers C1 and C2 is brought to be at the potential, which is produced by dividing the differential voltage between the power source terminal VD and the power source terminal VS, at the junction of the condensers C1 and C2 at the moment of the ESD surge. The condensers C1 and C2 are charged in accordance with the CR time constants of the resistor R1 and condensers C1 and C2.

At least during the CR time constant, the voltage of the gate of the transistor Tr1 is lower than that of the source (signal line S1) due to the voltage generated by dividing the differential voltage between the power source terminals VD and VS, bringing the source-drain path of the transistor Tr1 into the ON state. Accordingly, the ESD surge current runs through the source-drain path of the transistor Tr1. That is, the current caused by the negative ESD surge that occurs in the input/output terminal V on the basis of the power source terminal VD flows through the source-drain path of the transistor Tr1 and the diode D4. Thus, the internal circuit 10 is protected.

Assuming that the negative ESD surge based on the power source terminal VS occurs in the input/output terminal V, the ESD surge current flows through the power source terminal VS, the diode D4 and the input/output terminal V since the diode D4 is connected in the forward direction with respect to the polarity of the applied ESD surge voltage. Therefore, the internal circuit 10 is protected.

If the positive ESD surge based on the power source terminal VD occurs in the input/output terminal V, the ESD surge current runs through the input/output terminal V, the diode D3 and the power source terminal VD since the diode D3 is connected in the forward direction with respect to the polarity of the applied ESD surge voltage. As a result, the internal circuit 10 is protected.

Provided that the negative ESD surge based on the power source terminal VS occurs in the power source terminal VD, the ESD surge current flows through the power source terminal VS, the diodes D4 and D3, and the power source terminal VD since the diodes D3 and D4 are connected in the forward direction with respect to the polarity of the voltage of the ESD surge that occurs in the power source terminals VD and VS, thereby protecting the internal circuit 10. However, the ESD surge voltage remains applied to the signal lines S1 and S2 of the transistor Tr1. Since the power source terminal VS has the higher potential than the power source terminal VD, the impedance of the diode D2 in light of the relation with the power source terminal VS is low (the impedance of the diode D1 in light of the relation with the power source terminal VS is high). Accordingly, the potential of the power source terminal VS is supplied to the back gate of the transistor Tr1 via the diode D2. Consequently, the signal line S2 of the transistor Tr1 serves as a source, and the signal line S1 thereof a drain.

Due to a voltage drop in the ESD surge of the power source terminal VD based on the power source terminal VS, the series circuit comprising the condensers C1 and C2 is brought to be at the potential, which is produced by dividing the differential voltage between the power source terminal VD and the power source terminal VS, at the junction of the condensers C1 and C2 at the moment of the ESD surge. The condensers C1 and C2 are charged in accordance with the CR time constants of the resistor R1 and condensers C1 and C2.

At least during the CR time constant, the voltage of the gate of the transistor Tr1 is lower than that of the source (signal line S2) due to the voltage generated by dividing the differential voltage between the power source terminals VD and VS, which brings the source-drain path of the transistor Tr1 into the ON state. Therefore, the ESD surge current flows through the source-drain path of the transistor Tr1. In other words, a well tap of the drain and source of the transistor Tr1 runs the current without causing a parasitic action.

As described above, the diodes D1 and D2 are connected between the back gate of the transistor Tr1 and the power source terminals VS and VD, respectively, to supply the ESD surge voltages produced in the power source terminals VS and VD to the back gate of the transistor Tr1. Additionally, the source and drain of the transistor Tr1 are switched to each other. As a result, the ESD surge current runs through the source-drain path without generating the parasitic action in the well tap of the source and the drain, which enables the prevention of a damage to the transistor Tr1.

Moreover, it is possible, only by connecting the diodes D1 and D2 between the back gate of the transistor Tr1 and the signal lines S1 and S2, to avoid the damage to the transistor Tr1 without enlarging a circuit area.

In addition, it is desirable to equalize the impedance of the parallel circuit having the resistor R1 and condenser C1 with that of the condenser C2. If a voltage drop in a path between the signal line S1 and the gate of the transistor Tr1 is made equal to that in a path between the signal line S2 and the gate, it becomes possible to give similar characteristics to an ON-operation of the source-drain path of the transistor Tr1 with the signal line S1 serving as a source and an ONoperation with the signal line S2 serving as a source.

When the power source terminal VS functions as a ground, and a positive direct current voltage is applied to the power source terminal VD, both the gate of the transistor Tr1 and the condenser C1 have high impedance. For that reason, the current caused by the direct current voltage does not run though the resistor R1. Consequently, there is no potential difference in the source-gate path of the transistor Tr1, which brings the source-drain path of the transistor Tr1 into an OFF state. That is, the direct current voltage is applied to the internal circuit 10, and the internal circuit 10 performs the predetermined operation.

When a plurality of internal circuits are to be protected, a power source line supplied with a power source of each internal circuit may be connected to the power source terminals VS and VD. Moreover, diodes may be connected between an input/output terminal of each internal circuit and the power source terminal VS, and between the input/output terminal and the power source terminal VD, respectively.

A second embodiment of the present invention will now be described with reference to the drawings.

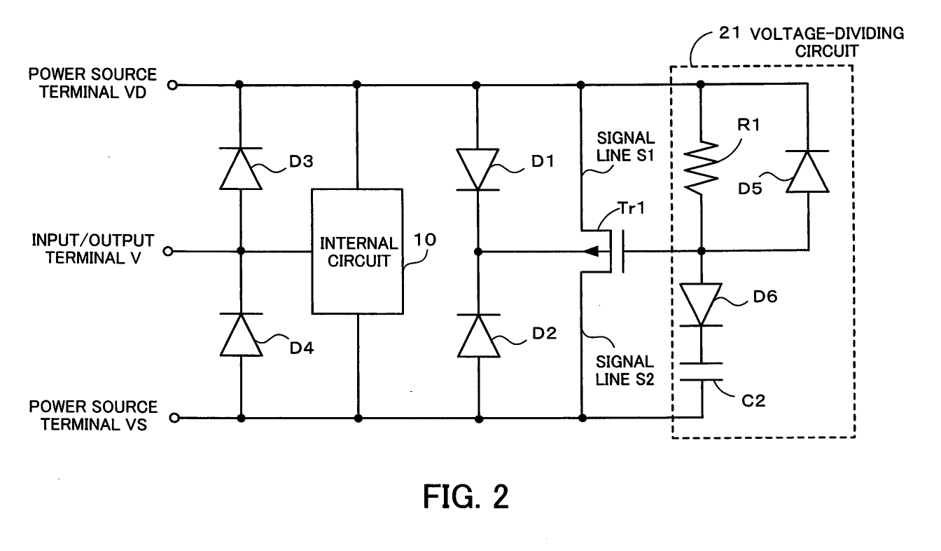

FIG. 2 shows an ESD protection circuit according to the second embodiment of the present invention. Similar parts to those shown in FIG. 1 are designated by the same reference characters, and the explanation thereof will be omitted. In FIG. 2, a voltage-dividing circuit 21 has a different construction from that of the voltage-dividing circuit 20 shown in FIG. 1. As illustrated in FIG. 2, on the contrary to the voltage-dividing circuit 20, the voltage-dividing circuit 21 includes a diode D5 instead of the condenser C1. The diode D5 has an anode connected to a gate of a transistor Tr1. Connected between the gate of the transistor Tr1 and a condenser C2 is a diode D6. The diode D6 has an anode connected to the gate of the transistor Tr1.

In FIG. 2, on condition that a positive ESD surge based on a power source terminal VS occurs in a power source terminal VD, a current is not produced since diodes D3 and D4 are connected in the backward direction with respect to the polarity of the ESD surge voltage.

Since the potential of the power source terminal VD is higher than that of the power source terminal VS, impedance of a diode D1 in light of a relation with the power source terminal VD is low (impedance of a diode D2 in light of a relation with the power source terminal VS is high). Therefore, the potential of the power source terminal VD is supplied to a back gate of the transistor Tr1 via the diode D1. Thus, a signal line S1 of the transistor Tr1 serves as a source, and a signal line S2 thereof a drain.

Since the diode D6 is connected in a forward direction with respect to the polarity of the ESD surge voltage, the current flows through a resistor R1, the diode D5 and the condenser C2. The condenser C2 is charged in accordance with a CR time constant of the resistor R1 and that of the condenser C2. At least during the CR time constant, the voltage of the gate of the transistor Tr1 is lower than that of the source (signal line S1) due to a voltage drop of the resistor R1, thereby bringing a source-drain path of the transistor Tr1 into an ON state. That is, the current caused by the positive ESD surge that occurs in the power source terminal VD on the basis of the power source terminal VS runs through the source-drain path of the transistor Tr1 and the power source terminal VS. Thus, an internal circuit 10 is protected.

In cases where a negative ESD surge based on the power source terminal VS occurs in the power source terminal VD, the ESD surge current flows through the power source terminal VS, the diodes D4 and D3, and the power source terminal VD since the diodes D3 and D4 are connected in the forward direction with respect to the polarity of the ESD surge voltage. The internal circuit 10 is accordingly protected. However, the ESD surge voltage remains applied to the signal lines S1 and S2 of the transistor Tr1. Since the power source terminal VS is higher in potential than the power source terminal VD, impedance of the diode D2 in light of the relation with the power source terminal VS is low (impedance of the diode D1 in light of the relation with the power source terminal VS is high). Therefore, the potential of the power source terminal VS is supplied to the back gate of the transistor Tr1 via the diode D2. As a consequence, the signal lines S2 and S1 of the transistor Tr1 serve as a source and a drain, respectively.

The gate of the transistor Tr1 has the same potential as the power source terminal VD since the current does not flow through the resistor R1 due to a backward connection of the diode D6. That is, since the voltage of the signal line S2 of the transistor Tr1 is higher than that of the gate, the source-drain path of the transistor Tr1 is brought into the ON state. On the contrary, the gate voltage of the transistor Tr1, which possesses a parasitic capacity of the diode D6, has potential equivalent to that of the source (signal line S2) only during a period when depending on the parasitic capacity. Thus, the source-drain path of the transistor Tr1 is brought into the OFF state. It is prevented, however, that the gate of the transistor Tr1 has the same potential as the source thereof by charging the parasitic capacity of the diode D6 through the diode D5. Consequently, the source-drain path of the transistor Tr1 is brought into the ON state.

An explanation of the operation in other conditions in which the ESD surge occurs in the power source terminals VD and VS and the input/output terminal V will be omitted since the voltage-dividing circuit 20 and the transistor Tr1 in the first embodiment operate similarly to the voltage-dividing circuit 21 and the transistor Tr1 in the second embodiment, and the other parts operate in the same manner.

By giving directionality to the current flowing through the voltage-dividing circuit 21 using the diodes D5 and D6 as described above, a potential difference can be surely produced between the gate of the transistor Tr1 and the signal lines S1 and S2, and the source-drain path of the transistor Tr1 can be brought into the ON state. Furthermore, the unidirectional current flow enables the use of the condenser having a polarity.

As stated above, in the present invention, the positive discharge voltage generated in the first power source terminal is supplied to the back gate of the transistor through the first diode, and the positive discharge voltage generated in the second power source terminal is supplied to the back gate of the transistor through the second diode, thereby to switch the source and the drain connected to the first and the second power terminal, respectively.

Consequently, the current produced by the discharge voltage runs through the source-drain path without causing the parasitic action in the well tap of the source and the drain, thus preventing damages to the transistor.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An electrostatic discharge protection circuit for protecting an internal circuit of a semiconductor device against an electrostatic discharge, comprising:
an internal circuit connected with a first and a second power source terminal;
a transistor switching a source and a drain connected to the first and the second power source terminal, respectively, in accordance with voltage supplied to a back gate;
a first diode connected between the first power source terminal and the back gate, the first diode supplying a positive discharge voltage generated in the first power source terminal to the back gate;
a second diode connected between the second power source terminal and the back gate, the second diode supplying a positive discharge voltage generated in the second power source terminal to the back gate; and
a voltage-dividing circuit dividing and supplying the discharge voltages to the gate of the transistor, the voltage-dividing circuit controlling ON/OFF operation of a source-drain path of the transition.

2. The electrostatic discharge protection circuit according to claim 1, wherein the transistor comprises:
a first power source terminal side serving as a source when the positive discharge voltage is supplied from the first power source terminal to the back gate, and
a second power source terminal side serving as a source when the positive discharge voltage is supplied from the second power source terminal to the back gate.

3. The electrostatic discharge protection circuit according to claim 1, wherein the voltage-dividing circuit equally divides the discharge voltage and supplies the voltage to the gate.

4. The electrostatic discharge protection circuit according to claim 1, wherein the voltage-dividing circuit unidirectionally runs a current caused by the discharge voltage.

5. The electrostatic discharge protection circuit according to claim 1, comprising diodes connected between an input/output terminal of the internal circuit and the first and the second power source terminal, respectively, the diodes carrying the discharge voltage produced in the input/output terminal to the first and the second power source terminal, respectively, in the form of an electric current.
